(19) United States
(12) Patent Application Publication
(10) Pub. No.: US 2025/0074413 A1
(43) Pub. Date: Mar. 6, 2025

(54) SYSTEM AND METHOD FOR GENERATING SPEED LIMIT DATA

(71) Applicant: HERE Global B.V., Eindhoven (NL)

(72) Inventors: Alex AVERBUCH, Buffalo Grove, IL (US); Leon STENNETH, Chicago, IL (US); Bruce BERNHARDT, Wauconda, IL (US); Advait Mohan RAUT, Virar West (IN); Yuxin GUAN, Chicago, IL (US)

(21) Appl. No.: 18/241,451

(22) Filed: Sep. 1, 2023

(51) Int. Cl. B60W 30/14; B60W 60/00; G01C 21/00

(52) U.S. Cl. CPC B60W 30/146; B60W 60/001; G01C 21/3815; G01C 21/3837; B60W 2554/4041; B60W 2554/4044; B60W 2555/60

(57) ABSTRACT

A system is disclosed for generating speed limit data. The system may include a memory configured to store computer executable instructions and one or more processor configured to execute the instructions to receive sign data relating to one or more traffic entities. The sign data comprises at least one of: a set of speed values, a set of transportation mode values, and one or more entity parameters associated with the corresponding one or more traffic entities. The processors are further configured to generate matching data based on a matching between the set of speed values and the set of transportation mode values, based on the one or more entity parameters. The processors are further configured to generate speed limit data based at least on: the matching data, the sign data and a predefined condition associated with transportation mode.

### TECHNOLOGICAL FIELD

The present disclosure relates generally to map databases, and more particularly to systems and methods for generating accurate speed limit data for the map databases.

### BACKGROUND

Traffic entities are provided along link segments to provide information to drivers and ensure safe movement of vehicles on the link segments. The traffic entities may give information about, for example, road conditions, instructions to be followed at crossroads or junctions, warnings or guide for drivers, and so forth. To this end, the traffic entities may ensure the proper functioning of road traffic. In an example, the traffic entities may include traffic sign boards indicating speed limit associated with different modes of vehicles for travelling on corresponding link segments.

To this end, determining speed limit indicated by a traffic sign board installed along a link segment may be crucial for generating navigation instructions. For example, the speed limit may be used to ensure appropriate consideration of safe travel speeds for travelling on the link segment and further, use such speed limit for precise travel time determination. The speed limit indicated by the traffic sign board may ensure safe and seamless navigation of a vehicle on the link segment.

In an example, speed limit indicated by multiple traffic sign boards provided along link segments may be used to generate speed limit data. For example, the speed limit data may include a decreasing speed limit along a route across the link segments. To this end, the speed limit data may be used to generate navigation instructions indicating decreasing speed limit, warn drivers, and provide road and/or traffic information to drivers. In certain cases, the speed limit data may be used to predict road conditions and appropriately provide updated generate navigation instructions or warnings to drivers of vehicles. The speed limit data is even more crucial in case of autonomous vehicles for reliable and efficient control of such autonomous vehicles during such decreasing speed limit.

However, conventional methods for detecting the traffic sign boards and generating speed limit data are prone to errors. The generated speed limit data may be highly inaccurate, thereby affecting generation of reliable navigation instructions, generation of accurate travel times, as well as reliable autonomous control of vehicles. Subsequently, incorrect speed limit data may affect routing and navigation of the vehicles travelling on the link segments. Therefore, there is a need for generating accurate speed limit data for efficient and safe navigation of vehicles.

### BRIEF SUMMARY

In order to solve the foregoing problem, the present disclosure may provide a system, a method and a computer programmable product that generates accurate speed limit data for efficient navigation services. The system and the method provide techniques for receiving sign data relating to one or more traffic entities on one or more link segments. The techniques disclosed in the present disclosure enable matching a speed value associated with a traffic entity with a corresponding transportation mode value. In this manner, matching data may be generated for the one or more traffic entities having speed limit values and transportation mode values. Further, on identifying a series of matching data associated with the one or more traffic entities having speed limit values and satisfying a precondition associated with transportation mode, speed limit data may be generated. For example, the generated speed limit data may relate to link segments having the traffic entities relating to the series of matching data.

In this manner, the techniques disclosed in the present disclosure enable to generate accurate speed limit data to help drivers to control driving actions, for example, slow down vehicle or re-route to a different link segment, on determining decreasing speed limit.

A system, a method, a computer programmable product are provided for generating speed limit data based on one or more traffic entities.

In one aspect, a system for generating speed limit data is disclosed. The system comprises a memory configured to store computer-executable instructions, and one or more processors configured to execute the computer-executable instructions. The one or more processors are configured to receive sign data relating to one or more traffic entities. The sign data comprises at least one of: a set of speed values, a set of transportation mode values, and one or more entity parameters associated with the corresponding one or more traffic entities. The one or more processors are further configured to generate matching data based on a matching between the set of speed values and the set of transportation mode values, based on the one or more entity parameters. The one or more processors are further configured to generate speed limit data based at least on: the matching data, the sign data and a predefined condition associated with transportation mode.

In additional system embodiments, the one or more processors are further configured to generate a speed value cluster based on the one or more entity parameters, the speed value cluster comprising a set of speed cluster points corresponding to each of the set of speed values. The one or more processors are further configured to generate a mode cluster based on the one or more entity parameters, the mode cluster comprising a set of mode cluster points corresponding to each of the set of transportation mode values.

In additional system embodiments, the one or more processors are further configured to generate the matching data comprising one or more matching pairs based on the set of speed cluster points, the mode cluster points and a distance threshold. A matching pair from the one or more matching pairs comprises a first speed cluster point from the set of speed cluster points matched with a corresponding first mode cluster point from the set of mode cluster points, a distance between the first speed cluster point and the first mode cluster point being less than the distance threshold.

In additional system embodiments, the one or more processors are further configured to generate the speed limit data for a first transportation mode when two or more matching pairs from the matching data are associated with the first transportation mode and a distance between the two or more matching pairs is less than a predefined threshold. The one or more processors are further configured to generate the speed limit data when two or more speed cluster points from the set of speed cluster points are independent of mode cluster points and a distance between the two or more speed cluster points is less than the predefined threshold. The one or more processors are further configured to generate the speed limit data for a first mode of transportation when one or more matching pairs from the matching data are associated with the first mode of transportation, one or more speed cluster points from the set of speed cluster points are independent of a mode of transportation and a distance between the one or more matching pairs and the one or more speed cluster points is less than the predefined threshold.

In additional system embodiments, the one or more processors are further configured to update a map database based on the generated speed limit data. The one or more processors are further configured to generate navigation instructions based on the updated map database.

In additional system embodiments, the generated speed limit data indicates a decreasing speed limit data.

In additional system embodiments, the one or more processors are further configured to generate the matching data and the speed limit data using a trained machine-learning based computational network. The trained machine-learning based computational network is trained based on a set of vehicle features, a set of entity features and a set of map features.

In additional system embodiments, to train the machine-learning based computational network, the one or more processors are further configured to receive training data comprising a set of vehicle features of one or more vehicles, a set of entity features of one or more traffic entities, a set of map features and ground truth data associated with valid speed limit data and invalid speed limit data. The one or more processors are further configured to determine a plurality of features corresponding to the valid speed limit data and the invalid speed limit data, using the training data. The one or more processors are further configured to train the machine-learning based computational network to generate test speed limit data for one or more test sign data, using the plurality of features and the set of training data.

In additional system embodiments, the one or more entity parameter comprises at least one of: corresponding distance, corresponding heading, corresponding side of a road, and corresponding link ID relating to the corresponding one or more traffic entities.

In additional system embodiments, the one or more processors are further configured to determine roadwork zone based on the speed limit data, the speed limit data indicating an end speed limit less than a speed threshold. The one or more processors are further configured to generate navigation instructions based on the determine roadwork zone.

In another aspect, a method for generating speed limit data is provided. The method comprises receiving sign data relating to one or more traffic entities. The sign data comprises at least one of: a set of speed values, a set of transportation mode values, and one or more entity parameters associated with the corresponding one or more traffic entities. The method further comprises generating matching data based on a matching between the set of speed values and the set of transportation mode values, based on the one or more entity parameters. The method further comprises generating speed limit data based at least on: the matching data, the sign data and a predefined condition associated with transportation mode.

In yet another aspect, a computer program product comprising a non-transitory computer readable medium having stored thereon computer executable instructions which when executed by at least one processor, cause the processor to carry out operations for generating speed limit data is provided. The operations comprise receiving sign data relating to one or more traffic entities. The sign data comprises at least one of: a set of speed values, a set of transportation mode values, and one or more entity parameters associated with the corresponding one or more traffic entities. The operations further comprise generating matching data based on a matching between the set of speed values and the set of transportation mode values, based on the one or more entity parameters. The operations further comprise generating speed limit data based at least on: the matching data, the sign data and a predefined condition associated with transportation mode. The operations further comprise generating a speed value cluster based on the one or more entity parameters, the speed value cluster comprising a set of speed cluster points corresponding to each of the set of speed values The operations further comprise generating a mode cluster based on the one or more entity parameters, the mode cluster comprising a set of mode cluster points corresponding to each of the set of transportation mode values.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a schematic diagram of an environment where a system for generating speed limit data is implemented, in accordance with an embodiment of the present disclosure;

FIG. 2 illustrates a block diagram of a system for generating speed limit data, in accordance with an embodiment of the present disclosure;

FIG. 3A, FIG. 3B, and FIG. 3C illustrate schematic diagrams indicating predefined conditions for generating speed limit data, in accordance with an embodiment of the present disclosure;

FIG. 4 illustrates flowchart of a method for generating a speed limit data, in accordance with an embodiment of the present disclosure;

FIG. 5A illustrates a schematic of generating a speed value cluster on a graph, in accordance with an embodiment of the present disclosure;

FIG. 5B illustrates a schematic of generating a mode cluster on the graph, in accordance with an embodiment of the present disclosure;

FIG. 5C illustrates a schematic of generating matching data using the graph, in accordance with an embodiment of the present disclosure;

FIG. 6 illustrates flowchart of a method for training a computational network for generating speed limit data, in accordance with an embodiment of the present disclosure;

FIG. 7 illustrates flowchart of a method for generating navigation instruction using speed limit data, in accordance with an embodiment of the present disclosure; and

FIG. 8 illustrates flowchart of a method for generating speed limit data, in accordance with an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “road” may refer to a way leading a traveler from one location to another. The road may have a single lane or multiple lanes.

The term “lane” may refer to a part of a road that is designated for travel of vehicles or pedestrians as per some condition.

The term “link” may be used to refer to any connecting pathway with a pre-defined length. Examples of the link including, but not limited to, a roadway, a highway, a freeway, an expressway, a lane, a street path, a road, an alley, a controlled access roadway, a free access roadway and the like. In an example, a link may have one or more lanes. For example, the link may include at least one lane for upward traffic direction and at least one lane for downward traffic direction. To this end, the term “link segment” may refer to a part of the link. For example, the link segment may have a predefined distance, such as 1 km, 3 km, 5 km, 10 km, and so forth.

The term ‘route’ may be used to refer to a path from a source location to a destination location. For example, a route may include multiple link segments. In an example, a favorable route may be determined based on one or more possible link segments for connecting the source location to a destination location, distance associated with the one or more possible link segments a level of traffic or traffic condition associated with the one or more possible link segments, and estimated travel times.

The term “traffic entities” may refer to traffic signs and/or road signs for providing instructions or information to users of road or link segments. In an example, the traffic entities may include traffic and/or road sign boards or display devices that may be erected or installed along link segments for providing information, instructions and/or warnings for travelling on the corresponding link segments. Pursuant to present disclosure, the traffic entities may indicate, for example, speed limit for travelling on corresponding link segments. In particular, a traffic entity may include a speed value indicating a speed limit. In certain cases, the traffic entity may also include a transportation mode value indicating a mode of transportation or vehicle type to which the speed value or the speed limit applies.

The term “sign data” may refer to data collected from one or more traffic entities. It may be noted that a traffic entity may be associated with a link segment on which the traffic entity is installed or erected. For example, the sign data may include speed values indicating speed limits associated with corresponding traffic entities and link segments, transportation mode values indicating mode of transportation associated with corresponding traffic entities and speed values, and one or more entity parameters associated with corresponding traffic entities.

The term “speed limit data” may refer to speed information derived from a group of two or more traffic entities indicating a change in speed values, i.e., change in speed limit, For example, the speed limit data relates to the group of two or more traffic entities when the two or more traffic entities indicate a decrease in speed value or speed limit. To this end, link segments associated with the group of two or more traffic entities may be sequentially connected, such that a starting point of a link segment may be ahead of an end point of another link segment and within a predefined threshold. Subsequently, the group of two or more traffic entities may be positioned consecutively, for example, within a predefined threshold from one another, thereby forming a route via the associated link segments. Therefore, the speed limit data indicates decreasing speed values along the route formed across the link segments associated with the group of two or more traffic entities.

In certain cases, the speed limit data may be used as an indication for an upcoming roadwork zone, an upcoming tunnel on a pathway, an upcoming crowded area, an upcoming transition from a highway to a ramp, an upcoming road area with poor road condition, and so forth.

### End of Definitions

A system, a method, and a computer program product are provided herein in accordance with an example embodiment for generating speed limit data. The conventional systems and methods for generating speed limit data may be inaccurate. For example, conventional systems and methods may generate speed limit data based on false positives, i.e., approve speed limit data that may be incorrectly generated based on speed values relating to different modes of transportation. For example, conventional systems and methods may use only speed values associated with traffic entities for generating speed limit data. In a case where a sequence of decreasing speed values is received, such speed values may be used for generating speed limit data. However, the speed values may be associated with different modes of transportation. For example, a first speed value obtained from a first traffic entity indicating a speed limit of 70 kilometers per hour (kmph) for cars, a second speed value obtained from a second traffic entity indicating a speed limit of 65 kmph for cars, and a third speed value obtained from a third traffic entity indicating a speed limit of 60 kilometers per hour (kmph) for trucks may be combined to form speed limit data. The speed limit data may be generated without considering that the third traffic entity does not belong to a same mode of transportation as the first traffic entity and the second traffic entity. This may cause false positives, i.e., generation of speed limit data based on false assumptions. Further, such false positives in generation of speed limit data may cause incorrect detection of decreasing speed limit.

In certain cases, the speed limit data may be used in autonomous or semi-autonomous vehicles for determining a switching time for switching between autonomous driving mode and manual driving mode. Some embodiments are based on the realization that decreasing speed limit data may indicate an approaching crowded area (such as schools, colleges, market place, and so forth), an approaching road work or construction site, an approaching link segment having poor road condition, and so forth. Therefore, on identifying decreasing speed limit based on the speed limit data, it may be beneficial to switch from the autonomous driving mode to manual driving mode to ensure safe operation of the vehicle. Moreover, the speed limit data may be used to control an autonomous or a semi-autonomous vehicle for reliable and efficient navigation within prescribed speed limit on road. In such cases, the speed limit data may also be crucial in deciding how to regulate speed of autonomously driven vehicle.

To this end, in some cases, incorrect speed limit data may produce false detection of road works, poor road condition, upcoming traffic or crowded area, and so forth. As a result, such false detection may cause incorrect update of a map database that may further cause erroneous routing decisions. In such cases, self-driving autonomous vehicles may incorrectly transition from autonomous mode to manual driving mode thereby hampering user experience and affecting operation of the autonomous vehicles. Moreover, switching to manual mode too soon or too late may hamper user experience and may also be hazardous and risky in some cases. In addition, decreasing speed of vehicle unnecessarily based on incorrect speed limit data may also affect operation of the vehicle, increase travel times and may render autonomous navigation inefficient.

To overcome the aforesaid problems, embodiments of the present disclosure disclose techniques for generating accurate speed limit data.

The speed limit data may indicate a decreasing speed limit. In an example, based on the accurate speed limit data, the decrease in the speed limit along a route may be used as indication to identify, for example, road works, poor road condition, upcoming tunnel, upcoming transition from highway to ramp, approaching traffic or crowded area, and so forth, along the route. Further, based on identification of to a change in road condition of link segments along the route, effective navigation instructions may be generated. For example, based on accurate speed limit data, map database may be updated. Subsequently, the navigation service providers may use the updated map database for generating navigation instructions while avoiding such route or to warn drivers regarding such change in road condition. Moreover, a control system associated with an autonomous vehicle or a semi-autonomous vehicle may be able to determine switching time accurately such that the switching between autonomous driving mode and manual driving mode is performed efficiently, i.e., neither too late nor too soon.

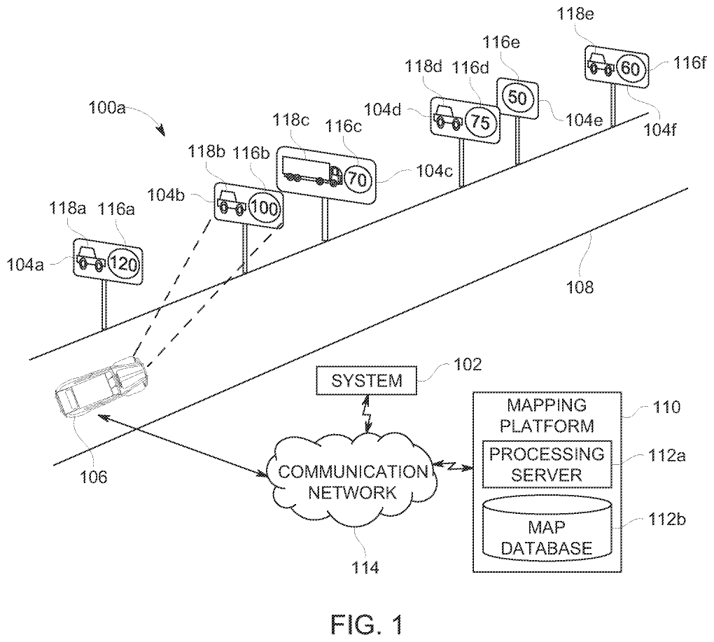

FIG. 1 illustrates a schematic diagram of an environment 100 where a system 102 for generating speed limit data is implemented, in accordance with an example embodiment. The environment 100 may include the system 102, one or more traffic entities (depicted as a traffic entities 104a, 104b, 104c, 104d, 104e, and 104f, and collectively referred to as traffic entities 104), a vehicle 106, and a link 108. For example, the traffic entities 104 are installed or erected along the link 108. In particular, the traffic entities 104 may correspond to link segments of the link 108. For example, the traffic entities 104 may indicate speed limit for different mode of transportation on corresponding link segments.

In an embodiment, the system 102 may be coupled to one or more user equipment, for example, as a part of an in-vehicle navigation system, a navigation app in a mobile device and the like, associated with the vehicle 106. In this regard, the system 102 may be communicatively coupled to the components shown in FIG. 1 to carry out the desired operations and wherever required modifications may be possible within the scope of the present disclosure.

In some example embodiments, the vehicle 106 may include processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, an image sensor such as camera, a display enabled user interface such as a touch screen display, and other components as may be required for specific functionalities of the vehicle 106. In some example embodiments, user equipment is associated, coupled, or otherwise integrated with the vehicle 106, such as an advanced driver assistance system (ADAS), a personal navigation device (PND), a portable navigation device, an infotainment system and/or other device that may be configured to provide route guidance and navigation related functions to the user.

In an example, the traffic entities 104 may be traffic sign boards indicating speed data. As shown, each of the traffic entities 104 may indicate an associated speed value (depicted as speed values 116a, 116b, 116c, 116d, 116e, and 116f, and collectively referred to as speed values 116, hereinafter). For example, the speed values 116 may be speed limit for travelling on the link 108. Moreover, some of the traffic entities 104, such as the traffic entities 104a, 104b, 104c, 104d and 104f also indicate an associated transportation mode value (depicted as transportation mode values 118a, 118b 118c, 118d, and 118e, and collectively referred to as transportation mode values 118, hereinafter). To this end, the transportation mode values 118 may indicate vehicle type associated with corresponding traffic entities 104. Moreover, the transportation mode values 118 may indicate vehicle type on which speed limit indicated by corresponding speed values 116 may apply.

The speed values 116 may be an integral value that indicates a speed limit that the vehicle 106 or other vehicles traveling along the link 108 should follow. As shown, the speed values 116 may have integral values of, for example, 120, 100, 70, 75, 50 and 60. The examples of the speed values 116, as shown in FIG. 1, are only exemplary and should not be construed as a limitation. Further, unit of the speed values 116 may be, for example, kilometers per hour (denoted as, kmph or kph), or miles per hour (denoted as, mph).

For example, certain traffic entities, such as the traffic entities 104a, 104b, 104c, 104d and 104f may indicate both the corresponding speed values 116a, 116b, 116c, 116d and 116f, as well as corresponding transportation mode values 118a, 118b, 118c, 118d and 118f. However, certain traffic entities, such as the traffic entity 104e indicate only the corresponding speed value 116f. In particular, the transportation mode values 118 associated with the traffic entities 104a, 104b, 104c, 104d and 104f indicate a mode of transportation or vehicle type for which the corresponding speed value 116 is valid. For example, the transportation mode values 118 may indicate the corresponding mode of transportation as, for example, a pictorial representation or drawings of a mode or vehicle type (such as an image of a car, a bus, a truck, etc.), or a text comprising a combination of letters indicating particular mode or vehicle type (such as text “car”, “bus”, “truck”, etc.). To this end, the traffic entities 104a, 104b, 104c, 104d and 104f indicate corresponding speed values 116a, 116b, 116c, 116d and 116f for different modes of transportation. As shown, the traffic entities 104a, 104b, 104d and 104f indicates the speed values 116a, 116b, 116d, and 116f for a car, whereas the traffic entity 104c indicates the speed value 116c for a heavy-duty commercial vehicle, such as truck, bus, or tractor.

In some example embodiments, the vehicle 106 may generate sensor data while travelling along the link 108 or lane segments on the link 108. In accordance with an embodiment, the sensor data may be generated by the vehicle 106, when sensor(s) on-board the vehicles 106 may sense traffic entities 104, for example, in vicinity of the vehicle 106 In accordance with an embodiment, the vehicle 106 may generate the sensor data in real-time and transmit it to the system 102 and/or the mapping platform 104 to report the traffic entities. To this end, such sensor data may be used to generate speed limit data. In certain cases, the speed limit data may be generated in real-time to help a driver of the vehicle 106 to navigate or rout along the link effectively.

In an example, user equipment may be installed in the vehicle 106 and is configured to detect sensor data on the link 108 by using image based sensors, i.e., image sources or cameras installed in the vehicle 106 or associated with the user equipment. The image source, the vehicle 106 or the user equipment may transmit the detected sensor data to the system 102, which processes the detected sensor data to generate speed limit data.

In an example embodiment, the system 102 may be onboard a vehicle, such as the system 102 may be a navigation system installed in the vehicle for determining traffic data and generating navigation instructions. In an example, the vehicle may be an autonomous vehicle, a semiautonomous vehicle, or a manually operated vehicle. In another example embodiment, the system 102 may be the processing server 104a of the mapping platform 104, and therefore may be co-located with or within the mapping platform 104.

The system 102 may be communicatively coupled to the vehicle 106, and the mapping platform 110, via the network 114. In an embodiment, the system 102 may be communicatively coupled to other components not shown on FIG. 1 via the network 114. All the components in the network environment 100 may be coupled directly or indirectly to the network 114. The components described in the network environment 100 may be further broken down into more than one component and/or combined together in any suitable arrangement. Further, one or more components may be rearranged, changed, added, and/or removed.

The system 102 may comprise suitable logic, circuitry, and interfaces that may be configured to determine speed limit data. The system 102 may be configured to obtain sign data, sensor data and map data corresponding to the link 108 from the map database 112b. In some example embodiments, as disclosed in conjunction with the various embodiments disclosed herein, the system 102 may be used to determine speed limit data associated with lane segments corresponding to the link 108 for enabling generation of precise navigation instructions, better estimation of travel times and providing alerts to drivers for warning them regarding possible road work along the link 108.

In an example, the map database 112b may contain link, lane and intersection data records or other data that may represent the link 108 in a route, pedestrian lane or areas in addition to or instead of the vehicle lanes. The links, lanes and intersections may be associated with attributes, such as geographic coordinates, street names, identifiers, lane traffic direction, address ranges, speed limits, turn restrictions at intersections, and other navigation related attributes, as well as POIs, such as fueling stations, hotels, restaurants, museums, stadiums, offices, auto repair shops, buildings, stores, and parks. The map database 112b may additionally include data about places, such as cities, towns, or other communities, and other geographic features such as, but not limited to, bodies of water, and mountain ranges.

The embodiments disclosed herein addresses the aforementioned problems relating to conventional speed limit data. In particular, owing to different traffic entities 104 along the link 108 indicating speed values for different modes of transportation, generating speed limit data may be difficult. The complexity in generating the speed limit data is aggravated due to convention data collection methods that acquire only speed values 116 from the traffic entities 104. The speed limit data thus generated using conventional methods may not be correct and may not apply to all modes of transportation. In order to overcome the aforementioned problems, the system 102 for determining speed limit data is disclosed.

In operation, the system 102 may be configured to receive sign data relating to the traffic entities 104. The sign data may include the speed values 116, the transportation mode values 118, and one or more entity parameters associated with the corresponding traffic entities 104. In an example, the sign data may include a set of integral values indicating the speed values that may be associated with corresponding traffic entities 104, and a set of labels corresponding to vehicle type indicating the transportation mode values 118 that may be associated with corresponding traffic entities 104. Moreover, the one or more entity parameters may include, for example, traffic entity identifier, geographic location, traffic orientation, and the like, associated with the corresponding traffic entities 104.

For example, the sign data may be received from vehicles, such as probe vehicles, commercial vehicles, passenger vehicles or any vehicle capable of sensing the traffic entities 104 and transmitting data, that may be travelling along the link 108. Such vehicles may collect data relating to the traffic entities 104 using one or more sensors and may transmit the data to the system 102 and/or the mapping platform 110. In an example, the mapping platform 110 may store the received data relating to the traffic entities 104 as sign data. In an example, the system 102 may be configured to obtain the sign data from the map database 112b.

Further, the system 102 may be configured to generate matching data based on a matching between the speed values 116 and the transportation mode values 118, based on the one or more entity parameters. In an example, based on geographic location, traffic entity identifier, and traffic orientation associated with a traffic entity, say the traffic entity 104a, a corresponding speed value 116a and a corresponding transportation mode value 118a may be identified. Further, the identified speed value 116a and the transportation mode value 118a may be matched to determine the matching data. In another example, the speed values 116 and the transportation mode values 118 may be plotted in a multi-dimensional space, based on the corresponding values and entity parameters associated with corresponding traffic entities 104. Further, the matching data may be generated based on matching of the speed values 116 and corresponding transportation mode values 118 in the multi-dimensional space.

In an example, the matching data may comprise matching pairs indicating a speed value mapped to a transportation mode value may indicate speed value mapped with a label of associated vehicle type or mode of transportation.

The system 102 may be configured to generate speed limit data based at least on: the matching data, the sign data and a predefined condition associated with transportation mode. For example, matching data and the sign data may be used to identify mapping of speed values 116 with corresponding transportation mode values 118, and certain speed values that may not have associated transportation mode values.

In an example, the predefined condition associated with transportation mode may indicate generating speed limit data by grouping two or more matching pairs being within a predefined threshold and having same transportation mode values. In such a case, generated speed limit data may relate to a particular transportation mode. For example, as the transportation mode values 118a, 118b, 118d and 118e is same, i.e., car, therefore, if traffic entities 104a, 104b, 104d and 104f are within predefined threshold from each other, then the corresponding speed values 116a, 116b, 116d and 116f may be used to generate speed limit data for travelling on the link 108 for a vehicle type ‘car ’.

In another example, the predefined condition associated with transportation mode may indicate generating speed limit data by grouping two or more matching pairs being within a predefined threshold and having either same transportation mode values, for example, relating to a first vehicle type, or no transportation mode values. In such a case, generated speed limit data may relate to the first vehicle type transportation mode. For example, as the traffic entities 104d and 104f have a same transportation mode values 118d and 118e, i.e., car, and the traffic entity 104e does not have a transportation mode value, therefore, if traffic entities 104d, 104e, and 104f are within predefined threshold from each other, then the corresponding speed values 116d, 116e, and 116f may be used to generate speed limit data for travelling on the link 108 or a link segment of the link 108 associated with the traffic entities 104d, 104e, and 104f for a vehicle type ‘car’.

In yet another example, the predefined condition associated with transportation mode may indicate generating speed limit data by grouping two or more matching pairs being within a predefined threshold and having no transportation mode values. In such a case, generated speed limit data may relate to any transportation mode. For example, if traffic entities having no transportation mode values are within predefined threshold from each other, then the corresponding speed values may be used to generate speed limit data for travelling on the link 108 for any vehicle type, such as “car”, “truck”, two-wheeler”, and the like.

In an example, the speed limit data generated by the system 102 may be used to determine a roadwork zone or populous zone in advance. In certain cases, if the speed limit data indicating decreasing speed limits indicates a sharp or sudden decrease in the speed values, for example, decrease in speed values of the speed limit data by half or more within a predefined distance, then a possibility of an approaching roadwork zone and/or an urban area or populous zone may be identified. To this end, the prior detection of the roadwork zone is utilized by the system 102 to switch from the autonomous driving mode to the manual driving mode seamlessly. This may help vehicle to navigate safely and avoid any accident.

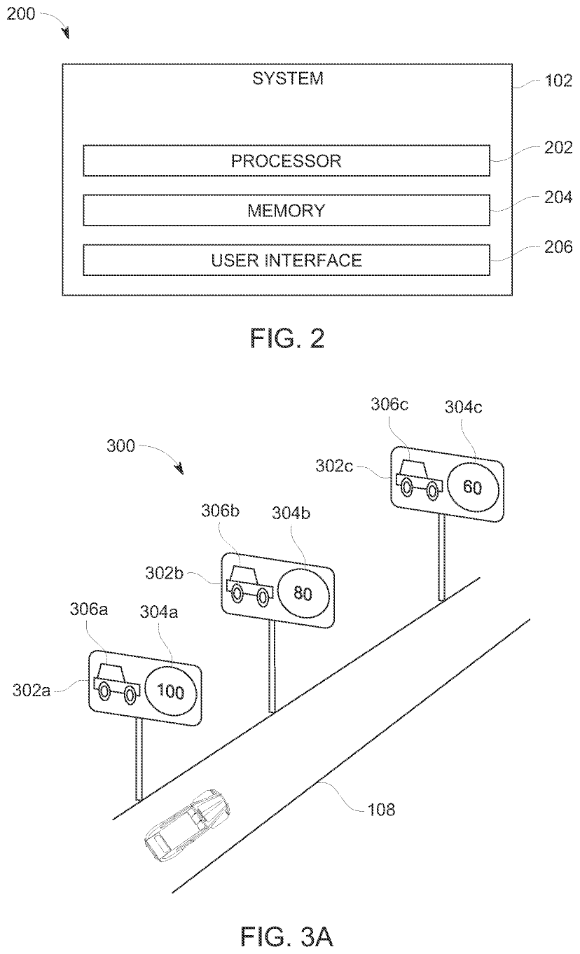

FIG. 2 illustrates a block diagram 200 of the system 102, exemplarily illustrated in FIG. 1 that may be used for generating speed limit data, in accordance with an example embodiment.

The system 102 may include one or more processor 202, a memory 204, and a user interface 206. The one or more processor 202 (referred to as processor 202, hereinafter) may be embodied in a number of different ways.

In accordance with an embodiment, the system 102 may store data that may be generated by the processor 202 while performing corresponding operation or may be retrieved from a database associated with the system 102, such as the map database 112b, in the memory 204. In an example, the data may include sensor data, sign data, matching data, speed limit data, traffic data, map data, probe data, one or more predefined thresholds, and navigation instructions.

The memory 204 may be non-transitory and may include, for example, one or more volatile and/or non-volatile memories. The memory 204 of the system 102 may be configured to store a dataset (such as, but not limited to, the sign data, the probe data, the matching data, speed limit data, and the map data) associated with multiple link segments within different links. In accordance with an embodiment, the memory 204 may include processing instructions for processing the sign data. The dataset may include real-time data and historical data, from service providers. The memory 204 of the system 102 may be configured to store the sensor data, sign data, the matching data, the speed limit processed sensor data, navigation instructions, map data, and routing related messages.

In some example embodiments, the system 102 may be implemented as a cloud based service that is accessible to vehicles such as the vehicle 106. Alternatively, the system 102 may be implemented in conjunction with one or more components of the vehicle 106 or may be fully implemented within the vehicle 106, itself. In an example, the processor 202 of the system 102 may be configured to generate the speed limit data based on sign data associated with the traffic entities 104.

In operation, the processor 202 may be configured to receive sign data relating to traffic entities 104. In an example, the processor 202 may receive the sign data by querying the mapping platform 110 and/or the map database 112b. For example, the sign data may comprise the speed values 116, the mode of transportation values 118, and one or more entity parameters associated with corresponding traffic entities 104. It may be noted that the speed values 116 may indicate speed limit for different transportation modes on the traffic entities 104, and the mode of transportation values 118 may indicate different transportation modes on different traffic entities 104. Moreover, the one or more entity parameters may indicate for example, an identifier, a direction, an orientation, a location, and so forth, associated with corresponding traffic entities 104.

In an example, the speed values 116 may be the speed limit that is mentioned on the traffic entities 104 for different mode of transportation for traveling along the link 108. Further, the transportation mode values 118 may include pictorial and/or textual representation of different modes of transportation. For example, the transportation mode values 118 may include, but is not limited to, image of car, image of truck, image of bus, image of a two-wheeler, text “car”, text “bus”, text “truck”, text “two wheeler”, and so forth. In certain cases, the traffic entities 104 may include only a corresponding speed value indication speed limit.

In some example embodiments, images may be received from the vehicle 106 or other probe vehicles travelling on the link 108, wherein the images relate to the traffic entities 104. The received images may be stored within the map database 112b of the mapping platform 110. In certain cases, the mapping platform 110 using the processing server 112a, or the system 102 may suitably process the received images. For example, such processing may include, suitably labeling the images based on geographic coordinates at which the corresponding images were captured, time of capturing, time of transmittal from the vehicle to the mapping platform 110, link 108 and/or link segment associated with the images, point of interests within the link 108 and/or the link segments and other information relating to respective link and/or link segment.

Pursuant to present example, the images received from the vehicle 106 may relate the traffic entities 104. Further, the processing of the images may also include identifying supplemental information, such as text and/or drawings associated with the traffic entities 104. In an example, the supplemental information corresponds to transportation mode values 118 associated with the traffic entities 104. To this end, the processing of an image of a traffic entity, say the traffic entity 104a may include identifying supplemental information indicating the transportation mode value 118a, such as identifying a drawing of car as supplemental information. Moreover, the processing of the image of the traffic entity 104a may include mapping the traffic entity 104a with a vehicle type label based on the supplemental value indicating the transportation mode value 118a, i.e., car, geographic coordinates, link 108, link segment, and so forth. In this manner, the image of the traffic entity 104a may be processed to identify a mode of transportation or a vehicle type to which the traffic entity 104a relates. Further, the processed and labeled images relating to the traffic entity may be stored within the map database 112b as a part of sign data.

Moreover, the vehicle 106 and/or other vehicles that may be probing or travelling along the link 108 may capture the speed values 116 off the traffic entities 104. For example, the vehicles may identify the traffic entities 104 and capture an integral value, i.e., the speed values 116 identified on the traffic entities 104. For example, the vehicles may use image sensors and/or other sensor to identify the speed values 116 and store the captured speed values 116 in a dataset. For example, the speed values may be associated with one or more entity parameters, for example, geographic location coordinates, traffic entity identifier, and the like.

Further, the one or more entity parameters may include information relating to the corresponding traffic entities 104. For example, the one or more entity parameters may include at least one of: a distance, geographical location coordinates, a heading, a side of road, a link ID, a link segment ID, a traffic entity ID, and so forth. The distance may be a distance between a traffic entity from one or more neighboring traffic entities. The heading is a direction in which the traffic entity is pointing or a direction of traffic or travel associated with link segment on which the corresponding traffic entity is positioned. For example, the headings are expressed as upstream traffic or uplink, and/or downstream traffic or downlink. To this end, a driving side of the link 108 may be, for example, left side or right side of the link: and a link ID or link segment ID or traffic entity ID may an alphanumeric, numeric or alphabetic set of characters, such as ‘XYZ’, ‘123’, ‘XY1’ and the like.

Continuing further, the processor 202 may be configured to generate matching data based on a matching between the set of speed values 116 and the set of transportation mode values 118, based on the one or more entity parameters. In an example, the matching data may include one or more matching pairs corresponding to the traffic entities 104. For example, a matching pair for the traffic entity 104a includes a matching between the speed value 116a and the corresponding transportation mode value118a. The matching between the speed value 116a and the corresponding transportation mode value118a may be performed based on the entity parameters of the traffic entity 104a, such as a traffic entity identifier, a location of the traffic entity 104a, a heading direction associated with the traffic entity 104a, a side of the link 108 or link segment at which the traffic entity 104a is positioned, and the like.

For example, the processor 202 may match a speed value, for example, a “100” from the speed values 116 and a transportation mode value, for example, “CARS” from the transportation mode values 118 to generate a matching pair 100 “CARS” based on the entity parameters associated with the speed value and the transportation mode value. In this manner, each of the speed values 116 may be matched with corresponding transportation mode values 118 to generate matching pairs.

In an example, the processor 202 may be configured to generate a speed value cluster based on the one or more entity parameters. The speed value cluster may include a set of speed cluster points corresponding to each of the speed values 116. Further, the processor 202 may be configured to generate a mode cluster based on the one or more entity parameters. The mode cluster may include a set of mode cluster points corresponding to each of the transportation mode values 118. For example, the speed value cluster and the mode cluster may be generated in a multi-dimensional space. To this end, the speed cluster points may be plotted in the multi-dimensional space to indicate speed values associated with each of the traffic entities 104 based on the entity parameters of the corresponding traffic entities. For example, such entity parameters may be defined on different axes in the multi-dimensional space. Similarly, the mode cluster points may be plotted in the multi-dimensional space to indicate transportation mode values associated with each of the traffic entities 104 based on the entity parameters of the corresponding traffic entities.

It may be noted that all traffic entities 104 may not indicate a transportation mode. Subsequently, all the speed cluster points corresponding to the speed values from the set of speed values 116 for the link 108 may not be matched with a corresponding mode cluster point of the transportation mode value. As certain traffic entities, such as the traffic entity 104e may only have a corresponding speed value 116a without any transportation mode value, the speed value 116e may not be matched with any mode of transportation or transportation mode value.

Continuing further, matching data may be generated for the sign data. The matching data may include one or more matching pairs based on the set of speed cluster points, the mode cluster points and a distance threshold. For example, if a distance between a speed cluster point and a mode cluster point is equal to or less than the distance threshold. It may be understood that if the distance between the speed cluster point and the mode cluster point is equal to or less than the distance threshold then the speed cluster point and the speed cluster point may relate to a same traffic entity. In this manner, a transportation mode value and a speed value associated with a traffic entity may be associated with each other to generate a matching pair.

Further, the processor 202 may be configured to generate a speed limit data based on the matching data, the sign data and a predefined condition associated with transportation mode. In an example, the generated speed limit data may form a speed funnel indicating a decreasing speed limit. In certain cases, the speed limit data may correspond to a particular transportation mode. To this end, based on the matching between the speed values 116 and the corresponding transportation mode values 118, the processor 202 may generate speed limit data based on the predefined conditions.

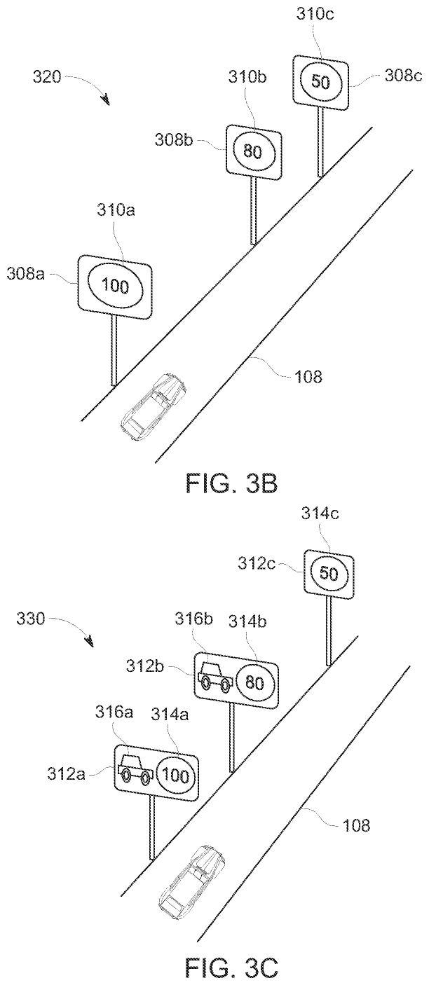

Once the speed limit data is generated for the link 108, the map database 112b corresponding to the link 108 may be updated to indicate the speed limit data. For example, the speed limit data may be generated for a particular transportation mode, such as “cars”. In such case, the map database may be updated to indicate a speed funnel for “cars” for travelling on the link 108. It may be noted that the generation of speed limit data for cars is only exemplary and should not be construed as a limitation. In other embodiments, the speed limit data may be generated for other transportation modes, such as buses, or two-wheelers, or the speed limit data may be independent of any transportation mode. Further, the predefined condition for generating the speed limit data is described in detail in conjunction with FIG. 3A, FIG. 3B, and FIG. 3C.

FIG. 3A, FIG. 3B, and FIG. 3C illustrate schematic diagrams 300, 320 and 330, respectively, indicating predefined conditions for generating speed limit data, in accordance with an example embodiment. For example, a predefined condition for generating the speed limit data may be based on a transportation mode value. In particular, based on the predefined conditions, multiple speed limit data may be generated for a same link, such as the link 108. Such multiple speed limit data may relate to, for example, different transportation modes and/or no transportation mode.

Referring to FIG. 3A, generation of speed limit data based on a first predefined condition is shown. Pursuant to present example, traffic entities 302a, 302b, and 302c having speed values 304a, 304b and 304c and transportation mode values 306a, 306b and 306c, respectively, are shown. For example, based on entity parameters relating to the traffic entities 302a 302b and 302c, a speed cluster point of the speed value 304a may be matched with a mode cluster point of the transportation mode value 306a, a speed cluster point of the speed value 304b may be matched with a mode cluster point of the transportation mode value 306b, and a speed cluster point of the speed value 304c may be matched with a mode cluster point of the transportation mode value 306c. In this manner, matching pairs for the traffic entities 302a 302b and 302c may be generated. Once matched, the speed limit data may be generated.

According to present example, the processor 202 may generate the speed limit data based on the first predefined condition indicating if two or more matching pairs, for example, matching pairs corresponding to the traffic entities 302a, 302b, and 302c are associated with a first transportation mode, i.e., same transportation mode and a distance between the two or more matching pairs is less than a predefined threshold, then a valid speed limit data may be generated for the first transportation mode. As depicted in the FIG. 3A, the matching pairs corresponding to the traffic entities 302a, 302b, and 302c include speed limit values 304a 304b and 304c corresponding to same transportation mode values 306a 306b and 306c. In other words, the speed limit values 304a 304b and 304c are associated with same transportation mode, i.e., “cars”, therefore speed limit data may generated for the same type of transportation mode, i.e., “cars” when the matching pairs from matching data corresponding to the traffic entities 302, 302b and 302c are within the predefined threshold, i.e., predefined threshold apart from each other.

Referring to FIG. 3B, generation of speed limit data based on a second predefined condition is shown. Pursuant to present example, traffic entities 308a, 308b and 308c having speed values 310a, 310b and 310c respectively, are shown. For example, the traffic entities 308a, 308b and 308c may be independent of transportation mode values. In an example, based on entity parameters relating to the traffic entities 308a, 308b and 308c, speed cluster points for each of the speed values 310a, 310b, 310c may be generated that is independent of any mode cluster points, i.e., mode of transportation. In this manner, the speed limit data may be generated based only on the speed values 310a, 310b, and 310c.

According to present example, the processor 202 may generate the speed limit data based on the second predefined condition indicating if two or more speed values, for example, two or more speed cluster points corresponding to the traffic entities 308a 308b and 308c are not associated with any transportation mode, i.e., are independent of matched mode cluster points and a distance between the two or more speed cluster points is less than a predefined threshold, then a valid speed limit data may be generated independent of any transportation mode. As depicted in the FIG. 3B, the traffic entities 308a, 308b, and 308c include speed limit values 310a, 310b, and 310c independent of transportation mode values. Therefore, speed limit data may generated independent of transportation mode, i.e., for any or all transportation modes, when the two or more speed cluster points corresponding to the traffic entities 308a 308b and 308c are independent of any mode cluster points and a distance between the two or more speed cluster points is within the predefined threshold, i.e., predefined distance threshold apart from each other.

Referring to FIG. 3C, generation of speed limit data based on a third predefined condition is shown. Pursuant to present example, traffic entities 312a, and 312b having speed values 314a, and 314b and transportation mode values 316a, and 316b, respectively, are shown. Moreover, a traffic entity 312c having only a speed value 314c, i.e., independent of any transportation mode values is also shown. For example, based on entity parameters relating to the traffic entities 312a, and 312b, a speed cluster point of the speed value 314a may be matched with a mode cluster point of the transportation mode value 316a, and a speed cluster point of the speed value 314b may be matched with a mode cluster point of the transportation mode value 316b. In this manner, matching pairs for the traffic entities 312a, and 312b may be generated. In addition, based on entity parameters relating to the traffic entity 312c, speed cluster point for the speed value 314c may be generated that is independent of any mode cluster points, i.e., mode of transportation. Further, the speed limit data may be generated based on the matching pairs and the speed value 314c.

According to present example, the processor 202 may generate the speed limit data based on the third predefined condition. The third predefined condition may indicate valid speed limit data if one or more matching pairs, for example, matching pairs corresponding to the traffic entities 312a and 312b are associated with a first mode of transportation, i.e., same transportation mode “cars”, and one or more speed cluster points, for example, a speed cluster point corresponding to the traffic entities 312c, is independent of a mode of transportation. The third predefined condition may also include a distance between the matching pairs corresponding to the traffic entities 312a and 312b and the speed cluster point corresponding to the traffic entities 312c should be is equal to or less than the predefined threshold, i.e., the matching pairs and the speed cluster point may be predefined threshold apart from each other to generate the valid speed limit data. In such a case, the generated speed limit data may correspond to the first mode of transportation, i.e., “cars”.

Based on the predefined condition, a valid speed limit data may be generated. The valid speed limit data may relate to a particular mode of transportation or may be independent of any mode of transportation. For example, valid speed limit data relating to a particular mode of transportation, say trucks, may be used to control an autonomous or a semi-autonomous vehicle that may be a trucks or a tractor. However, such speed limit data may not be applied to cars or two-wheelers. In this manner, accurate speed limit data may be generated for different modes of transportation. In certain cases, the speed limit data may also be used for determining an approaching roadwork zone or an approaching urban or crowded area. In such a case, since predefined condition indicates generation of speed limit data based on a singular or no mode of transportation, therefore, for example, identification of one or more traffic entities indicating higher speed limit for cars and one or more traffic entities indicating substantially low speed limit for trucks may not cause generation of a valid speed limit data. As a result, generation of false speed limit data may be avoided. Moreover, this may result in accurate prediction of approaching roadwork zone or approaching urban or crowded area. Based on accurate predictions, control systems associated with autonomous or semi-autonomous vehicles may be able to improving precision of switching time for switching control from autonomous driving mode to manual driving mode.

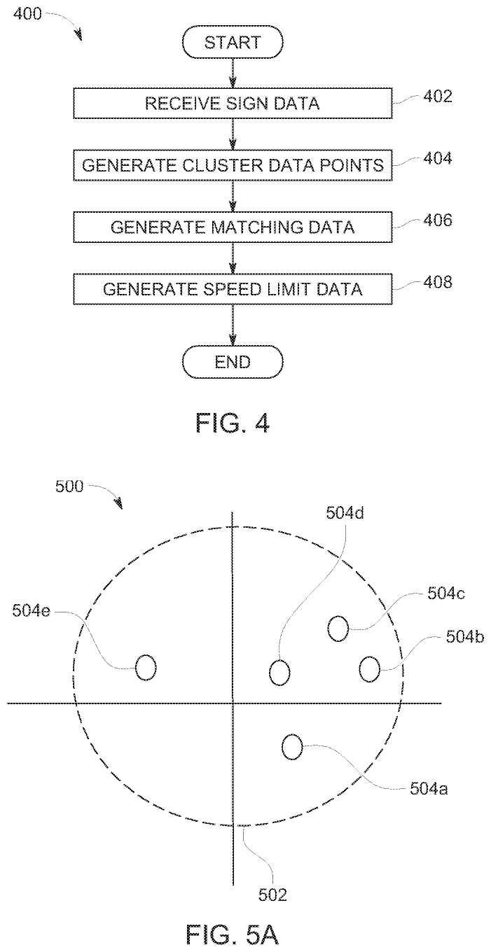

FIG. 4 illustrates a flow diagram of an example method 400 for generating a speed limit data, in accordance with an example embodiment. In an example, the processor 202 may be configured to generate the speed limit data based on a predefined condition. For example, different speed limit data may be generated for the particular link 108 based on different predefined conditions to control mobility of traffic on the link 108.

At 402, sign data is received. In an example, the processor 202 may be configured to receive sign data. The sign data may include, for example, information relating to the one or more traffic entities 104. For example, the sign data may include the speed values 116, the transportation mode values 118 and one or more entity parameters relating to the traffic entities 104. In an example, the sign data may be received from the mapping database 112b, and/or one or more vehicles probing or travelling on the link. For example, the vehicles may capture integral numerical values corresponding to the speed values 116 from the traffic entities 104, and transmit them to the system 102 and/or the mapping platform 110 as speed limits for travelling on the link 108. For example, the integral numerical values captured from the traffic entities 104 may be stamped with, for example, time, geographical location or coordinates, traffic entity identifier, link 108 identifier, link segment identifier, traffic direction, distance from one or more neighboring traffic identifier, and so forth. Such information corresponding to integral numerical values may form one or more entity parameters of the corresponding traffic entities 104.

In certain cases, the vehicles are also caused to capture images associated with the traffic entities 104 and transmit them to the system 102 and/or the mapping platform 110. In an example, the system 102 and/or the mapping platform 110 may be configured to process the images to identify supplemental texts or drawings indicative of transportation mode values. For example, different possible modes of transportation may have corresponding allocated transportation mode values. Subsequently, on identifying an image of a traffic entity, say the traffic entity 104a indicating having a first mode of transportation “cars” textually or graphically, a transportation mode value, e.g., “00” associated with the first mode of transportation, cars, may be allocated to the image. The image may also be stamped with one or more entity parameters relating to the traffic entity 104a.

For example, the received integral numerical values indicating to speed values 116 of the traffic entities 104, the processed images indicating transportation mode values of the traffic entities 104 and one or more entity parameters of the of the traffic entities 104 may be stored within the mapping database 112b and/or the memory 204 associated with the system 102.

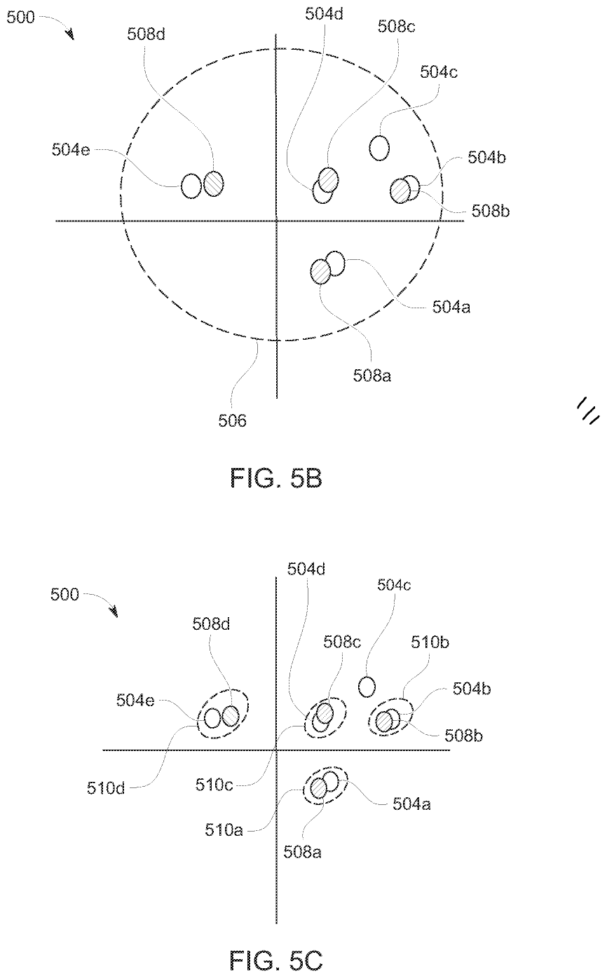

At 404, a speed value cluster may be generated. In an example, the processor 202 may be configured to generate the speed value cluster based on the one or more entity parameters, such as location, distance, identifier, heading or traffic direction, etc. A manner in which the speed value cluster is generated is explained in conjunction with FIG. 5A.

Referring to FIG. 5A, a schematic illustration for generating a speed value cluster 502 on a graph 500 is shown, in accordance with an example embodiment. For example, the speed value cluster 502 may include a set of speed cluster points or data points (depicted as speed cluster points 504a, 504b, 504c 504d and 504e, and collectively referred to as speed cluster points 504) corresponding to each of the speed values 116. The speed cluster points 504 may represent the speed values 116.

For example, the speed value cluster 502 may be plotted in a multi-dimensional space. In such a case, the graph 500 may generate in the multi-dimensional space, and different axes of the graph 500 may correspond to the one or more entity parameters.

Continuing further, based on values corresponding to the one or more entity parameters associated with the traffic entity 104a and an integral numerical value or a speed value 116a of the traffic entity 104a, a speed cluster point, say speed cluster point 504a corresponding to the traffic entity 104a may be plotted. In this manner, speed cluster points 504 for each of the speed values 116 of the traffic entities 104 may be plotted.

Returning back to FIG. 4, at 406, a mode cluster is generated. In an example, the processor 202 may be configured to generate the mode cluster based on the one or more entity parameters. A manner in which the speed value cluster is generated is explained in conjunction with FIG. 5B.

Referring to FIG. 5B, a schematic illustration of generating a mode cluster 506 on the graph 500 is shown, in accordance with an example embodiment. For example, the mode cluster 506 may include a set of mode cluster points or data points (depicted as mode cluster points 508a, 508b, 508c and 508d, and collectively referred to as mode cluster points 508) corresponding to each of the transportation mode values 118. The mode cluster points 508 may represent the transportation mode values 118. For example, the mode cluster 506 may be plotted in the same graph in which the speed value cluster 502 is plotted.

Based on values corresponding to the one or more entity parameters associated with the traffic entity 104a and an allocated transportation mode value 118a of the traffic entity 104a, a mode cluster point, say mode cluster point 508a corresponding to the traffic entity 104a may be plotted in the graph 500. In this manner, mode cluster points 508 for each of the transportation mode values 118 of the traffic entities 104 may be plotted.

In an example, transportation values 118 associated with the traffic entities 104 may be indicative of a type of mode of transportation, such as cars, trucks, two-wheelers, and so forth. The transportation mode values 118 may also be indicative of entity parameters relating to corresponding traffic entities 1104. For example, different modes of transportation associated with the traffic entities 104 may be represented differently. For example, a first mode of transportation corresponding to cars may be plotted on the graph 500 using a first color, say red, or using a first type of data points. Further, a second mode of transportation corresponding to trucks may be plotted on the graph 500 using a second color, say red, or using a second type of data points Moreover, a third mode of transportation corresponding to two-wheelers may be plotted on the graph 500 using a third color, say blue, or using a third type of data points. In this manner, different modes of transportation corresponding to the traffic entities 104 may be differentiable on the graph 500, based on a representation of the mode cluster points 508.

Returning to FIG. 4, at 406, matching data is generated based on the speed value cluster 502 and the mode cluster 506. In an example, the processor 202 may be configured to generate the matching data based on matching between the speed cluster points 504 of the speed value cluster502 and the mode cluster points 508 of the mode cluster 506. A manner in which the matching data is generated is explained in conjunction with FIG. 5C.

Referring to FIG. 5C, a schematic illustration of generating matching data using the graph 500 is shown, in accordance with an example embodiment. In an example, the matching data may include one or more matching pairs (depicted as matching pairs 510a, 510b, 510c and 510d, and collectively referred as matching pairs 510). In particular, the matching pairs 510 may be identified based on a matching between the speed cluster points 504 and the mode cluster points 508. In this regard, the matching between a speed cluster point 504a and a mode cluster point 508a may be performed based on a distance between the speed cluster point 504a and the mode cluster point 508a. For example, if the distance between the speed cluster point 504a and the mode cluster point 508a is less than or equal to a distance threshold, the speed cluster point 504a and the mode cluster point 508a may be considered to belong to a same traffic entity, say the traffic entity 104a, and the speed cluster point 504a and the mode cluster point 508a may be matched to generate a matching pair 510a.

In this manner, based on matching speed cluster points 504 with mode cluster points 508 having a distance less than the distance threshold in the graph 500, the matching pairs 510 may be generated.

At 408, the speed limit data may be generated. In an example, the processor 202 may be configured to generate the speed limit data based on at least one of: the matching data, the sign data and a predefined condition associated with transportation mode is generated. In one embodiment example, speed limit data may be generated for same mode of transportation, say first mode of transportation “cars”. In an example, two or more matching pairs, say matching pairs 510a, 510b and 510c may be within a predefined threshold from each other. In such a case, the mode cluster points 508a, 508b and 508c associated with the matching pairs 510a, 510b and 510c may have same representation in terms of, for example, color, shading, etc. This may represent that the mode cluster points 508a, 508b and 508c associated with the two or more matching pairs 510a, 510b and 510c belong to a same mode of transportation, such as the first mode of transportation. Subsequently, speed limit data relating to the first mode of transportation may be generated based on the speed cluster points 504a, 504b and 504d of the matching pairs 510a, 510b and 510c.

In another example, one or more speed cluster points, say speed cluster point 504c from the speed cluster points 504 may also be within predefined threshold from two or more matching pairs, say the matching pairs 510a, 510b and 510c. In such a case, as the mode cluster points 508a, 508b and 508c associated with the matching pairs 510a, 510b and 510c have same representation indicating a same mode of transportation (or first mode of transportation) and the speed cluster point 504c is independent of mode of transportation, the speed cluster point 504c along with the speed cluster points 504a, 504b and 504d of the matching pairs 510a, 510b and 510c may be used to generate speed limit data relating to the first mode of transportation.

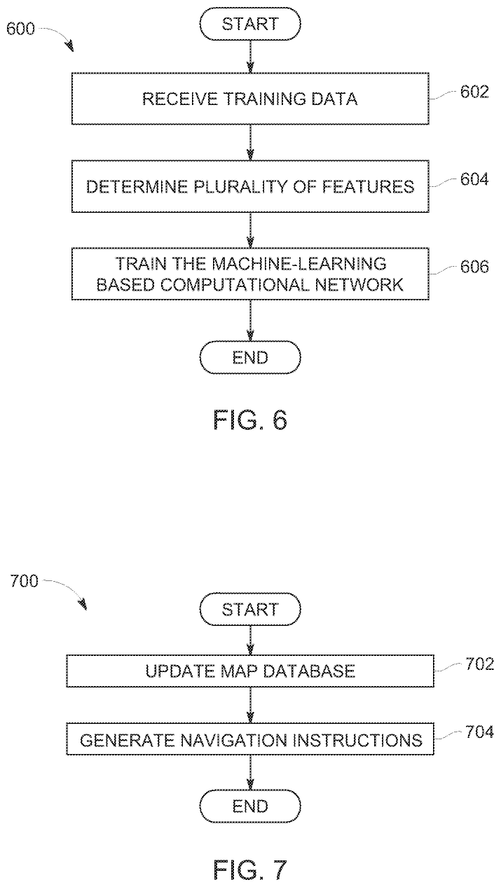

In another embodiment, the speed limit data may be generated for all modes of transportation, i.e., independent of any mode of transportation. In such case, if two or more speed cluster points from the speed cluster points 504 are within a predefined threshold from each other and does not have corresponding mode cluster points, i.e., does not form matching pairs, then the two or more speed cluster points may be used to generate speed limit data independent of any mode of transportation. For example, the predefined condition based on which the speed limit data is generated using the matched data and the sign data is described in detail in conjunction with FIG. 3A, FIG. 3B and FIG. 3C above. A manner in which the system 102 is trained to generate the speed limit data is described in conjunction with FIG. 6.

FIG. 6 illustrates a flow diagram of a method 600 for training a machine learning based computational network, in accordance with an example embodiment. The machine leaning based computational network may be trained to perform operations such as, generating matching data for traffic entities 104, and generating speed limit data. In various embodiments, the mapping platform 110 or the system 102 may perform one or more portions of the method 600 and may be implemented in, for instance, a chip set including a processor and a memory. As such, the mapping platform 110 or the system 102 may provide means for accomplishing various parts of the method 400, as well as means for accomplishing embodiments of other processes described herein in conjunction with other components of the system 102. Although the method 400 is illustrated and described as a sequence of steps, its contemplated that various embodiments of the method 400 may be performed in any order or combination and need not include all of the illustrated steps.

At 602, training data may be received. In an example, the processor 202 may receive training data. In an example, the training data may include, but is not limited to, a set of vehicle features of one or more vehicles, a set of entity features of one or more traffic entities, a set of map features and ground truth data associated with valid speed limit data and invalid speed limit data. For example, the processor 202 may be configured to retrieve the training data from the map database 112b and/or other databases associated with the system 102.

In an example, the set of vehicle features may include information relating to the one or more vehicles that may gather traffic entity information. For example, the vehicles may be probe vehicles, private vehicles, or commercial vehicles. The set of vehicle features may include, but is not limited to, speed of the vehicle when travelling on a link while gathering information, vehicle type or mode of vehicle, i.e., cars, bus, trucks, two-wheeler, and so forth, vehicle route, and information relating to sensors associated with vehicle.

Moreover, the set of entity features of the traffic entities may include features such as the speed value or speed limit indicated by traffic entities, image associated with traffic entities, transportation mode value indicated by traffic entities, traffic entity identifiers, geographic location associated with traffic entities, link identifiers associated with traffic entities, link segment identifiers associated with traffic entities, a traffic direction corresponding to link associated with traffic identifiers, distance from other neighboring traffic entities, and so forth.

Further, the set of map features may include, for example, lane and intersection data records, link data records or other data that may represent link in a route, pedestrian lane or areas in addition to or instead of the vehicle lanes. The lanes and intersections may be associated with attributes, such as geographic coordinates, street names, lane identifier, lane segment identifier, lane traffic direction, address ranges, speed limits, turn restrictions at intersections, and other navigation related attributes, as well as POIs, such as fueling stations, hotels, restaurants, museums, stadiums, offices, auto repair shops, buildings, stores, and parks. The set of map features may additionally include data about places, such as cities, towns, or other communities, and other geographic features such as, but not limited to, bodies of water, and mountain ranges.

Moreover, the ground truth data associated with valid speed limit data and invalid speed limit data may indicate, for example, valid speed limit data based on historically generated speed limit data relating to a single mode of transportation and having decreasing speed limits. In addition, invalid speed limit data may be based on historically generated speed limit data based on traffic entities relating to different modes of transportation and having decreasing speed limits.

At 604, a plurality of features relating to valid speed limit data and invalid speed limit data is determined. For example, the plurality of features of the valid speed limit data may be used to identify the predefined condition such as, how to determine distance threshold for generating matching pairs, how to determine predefined threshold, and other predefined condition associated with transportation mode values.

In an example, the traffic entities from the training data may be represented in a multi-dimensional space or a graph indicting corresponding speed limit value and transportation mode value, based on corresponding vehicle features, entity features, and map features. Further, based on the ground truth data, one or more valid speed limit data and one or more invalid speed limit data may be identified. Thereafter, plurality of features relating to valid speed limit data and invalid speed limit data may be determined. For example, the plurality of features relating to valid speed limit data and invalid speed limit data may be in terms of the corresponding vehicle features, entity features, and map features.

At 606, the machine-learning based computational network (referred as, the computational network, hereinafter) is trained to generate test speed limit data for one or more test sign data, using the plurality of features and the set of training data. The computational network may be trained based on the training data to identify the plurality of features. To this end, the computational network may be a neural network machine learning model, for example, artificial neural network (ANN), support vector model (SVM), convolution neural network (CNN), and so forth. For an example, the computational network may be based on, but not limited to, decision Trees or a random Forest.

Further, once trained, the computational network may be used to generate test speed limit data for one or more test sign data. In an example, based on the test sign data relating to test traffic entities, the trained computational network may be configured to generate test speed limit data. In an example, based on the plurality of features relating to valid speed limit data and invalid speed limit data, the trained computation network may be configured to identify valid speed limit data based on predefined conditions, as well as invalid speed limit data. For example, such invalid speed limit data may be dropped and the predefined conditions for valid and/or invalid speed limit data may be determined based on the plurality of features and/or the generated test valid and invalid speed limit data.

FIG. 7 illustrates a flow diagram of a method 700 for generating navigation instructions, in accordance with an example embodiment. In an example, the processor 202 may be configured to generate the navigation instructions. In another example, third-party navigation service providers may utilize map database 112b include the generated speed limit data to generate the navigation instructions. In an example, navigation instructions may include a set of directions or guidelines that help user to navigate through a route.

In this regard, at 702, the map database 112b may be updated. In an embodiment, the processor 202 may be configured to update the map database 112b based on the generated speed limit data. In an example, the generated speed limit data may indicate a decreasing speed limit across link segments on a route. It may be noted that such decreasing speed limit may be indicative of, for example, an upcoming roadwork zone, an upcoming tunnel on a pathway, an upcoming crowded area, or an upcoming transition from a highway to a ramp, an upcoming road area with poor road condition, and so forth.

In an example, based on the speed limit data, an approaching roadwork zone may be identified. For example, the approaching roadwork zone may be identified when an end speed limit in the speed limit data is less than a speed threshold. In an example, the speed threshold may be half of a start speed limit of the speed limit data. In accordance with an example, the speed limit data comprises speed values 100 kmph, 85 kmph, 70 kmph, 50 kmph and 30 kmph. In such a case, if the speed limit data corresponds to a link having a distance less than a link threshold, such as less than 3 km, 5 km, and so forth, then the speed limit data may be indicative of an approaching roadwork zone. To this end, the approaching roadwork zone may be identified when the end speed limit is reduced by half or more as compared to start speed limit, or is less than the speed threshold, over a short distance, i.e., for a link having distance less than the link threshold.

Furthermore, the map database 112b may be updated based on the generated speed limit data and information relating to identification of the approaching roadwork zone. The roadwork zone may be a portion of the road that may have numerous people working with heavy machinery. The roadwork zone may lead to a blockage on the road and may result in diversions or merging of the lanes of the road. Due to the generated accurate speed limit data, the processor 202 may accurately identify the roadwork zone. Such roadwork zone may require high attention of drivers. To this end, such early identification of roadwork zone may be used as a parameter for identifying a precise switching time for switching from autonomous driving mode to manual driving mode. A prior intimation of an approaching roadwork zone may avoid any accident from taking place at the roadwork zones.

At 704, navigation instructions are generated. In some embodiment, the processor 202 may be further configured to generate navigation instructions based on the updated map database 112b. The generated navigation instructions may include, but is not limited to, to user readable or user-understandable navigation instructions, such as routing messages, notifications, warning messages, etc., based on the traffic congestion or traffic condition, approaching roadwork zone, speed limit associated with links, and so forth. The navigation instructions may also include, for example, travel times, travel distance, favorable travel route, traffic incidents, traffic flows, traffic delays, driving behavior guide or navigation instructions, any real-time change along the route, and so forth.

In an example, the speed limit data may indicate speed limit that need to be followed on the corresponding link. As a result, accurate travel time may be determined based on such speed limit data. Moreover, warning messages may be provided based on speed limit data to indicate approaching roadwork zone, or any other instance of decreasing speed limit.

In certain cases, the navigation instructions may be utilized by a control system associated with an autonomous vehicle to control the vehicle automatically. In certain cases, based on decreased speed limit an approaching traffic area or roadwork zone may be identified. In such a case, navigation instructions may be generated to re-route vehicle to avoid such traffic area or roadwork zone.

The navigation instructions indicating the roadwork zone or approaching decreased speed limit may be helpful in avoiding unnecessary traffic, accidents, and avoiding sudden switching from the automatic mode to manual mode in autonomous or semi-autonomous vehicles. For example, generating navigation instructions based on the determined roadwork zone, may enable to warn any vehicle traveling towards the roadwork zone about the approaching roadwork zone by a plurality of warning indicators, such as, a “men at work”, speed limit signs, road work announcements, etc.

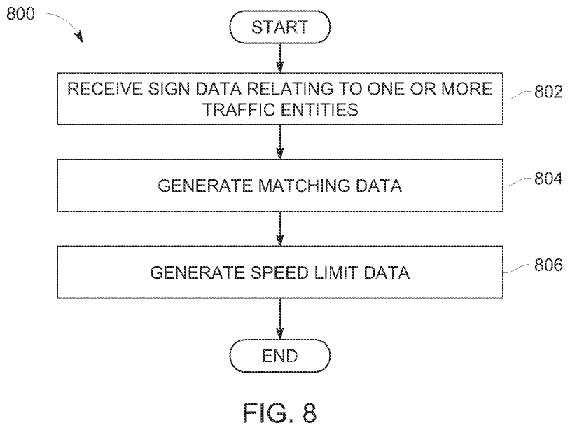

FIG. 8 illustrates a flow diagram of a method 800 for generating speed limit data, in accordance with an example embodiment. The steps of the method 800 may be implemented by the system 102 and/or the processor 202. Fewer, more, or different steps may be provided.

At 802, the method 800 comprises, receiving sign data relating to one or more traffic entities 104. The sign data may include, for example, a set of speed values 116, a set of transportation mode values 118, and one or more entity parameters associated with the one or more traffic entities 104. In an example, sign data may include speed limit captured from one or more traffic entities 104 installed along the link 108. The sign data may further include information relating to the transportation mode value 118 and the entity parameter such, as location, traffic entity identifier, link ID, link segment ID, traffic direction, etc.

At 804, the method 800 comprises, generating matching data based on a matching between the set of speed values 116 and the set of transportation mode values 118, based on the one or more entity parameters associated therewith. In an example, the processor 202 may be configured to generate the speed value cluster 502 based on the one or more entity parameters. The speed value cluster 502 may include the set of speed cluster points 504 corresponding to each of the set of speed values 116. Moreover, the processor 202 may be configured to generate a mode cluster 506 based on the one or more entity parameters. The mode cluster 506 may include a set of mode cluster points 508 corresponding to each of the set of transportation mode values 118. Further, one or more matching pairs 510 may be identified based on the set of speed cluster points 504, the mode cluster points 508 and a distance threshold.

In an example, a matching pair 510a from the one or more matching pairs 510 may include a first speed cluster point 504a from the set of speed cluster points 504 matched with a corresponding first mode cluster point 508a from the set of mode cluster points 508. Moreover, a distance between the first speed cluster point 504a and the first mode cluster point 508a is less than the distance threshold. Based on the matching pairs 510, the matching data may be generated.

At 806, the method 800 comprises, generating speed limit data based at least on: the matching data, the sign data and a predefined condition associated with transportation mode. In an example, processor 202 may generate speed limit data based on the matching data based on the predefined conditions. Due to the use of the predefined conditions, the speed limit data may relate to a single mode of transportation or may be independent of any mode of transportation.

In an example, a valid speed limit data may be generated for a first transportation mode when two or more matching pairs, say 510a and 510b, from the matching data are associated with the first transportation mode and a distance between the matching pairs 510a and 510b is less than a predefined threshold. In another example, a valid speed limit data may be generated independent of any mode of transportation when two or more speed cluster points from the set of speed cluster points 504 are independent of mode cluster points and a distance between the two or more speed cluster points is less than the predefined threshold. In another example, a valid speed limit data may be generated for a first mode of transportation when one or more matching pairs from the matching data are associated with the first mode of transportation and one or more speed cluster points from the set of speed cluster points 504 are independent of a mode of transportation, and a distance between the one or more matching pairs and the one or more speed cluster points is less than the predefined threshold.

Accordingly, blocks of the flowcharts 400, 600, 700 and 800 support combinations of means for performing the specified functions and combinations of operations for performing the specified functions. It will also be understood that one or more blocks of the flowcharts 400, 600, 700 and 800, and combinations of blocks in the flowcharts 400, 600, 700 and 800, can be implemented by special purpose hardware-based computer systems which perform the specified functions, or combinations of special purpose hardware and computer instructions.

Alternatively, the system 102 may comprise means for performing each of the operations described above. In this regard, according to an example embodiment, examples of means for performing operations may comprise, for example, the processor 202 and/or a device or circuit for executing instructions or executing an algorithm for processing information as described above.

On implementing the methods 400, 600, 700 and 800 disclosed herein, the end result generated by the system 102 is a tangible speed limit data for enabling navigation and routing operations. The speed limit data is crucial to provide accurate speed limits in navigation instructions, estimate travel times based on safe speed limits, as well as provide warnings based on identification of road work zones, approaching traffic, poor road condition, and the like, thereby ensuring driver safety.

Returning to FIG. 1, the user equipment may be any user accessible device such as a mobile phone, a smartphone, a portable computer, and the like that are portable in them or as a part of another portable/mobile object such as the vehicle. In such example embodiments, the user equipment comprises processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment. For example, the user equipment may be configured to execute and run mobile applications such as a messaging application, a browser application, a navigation application, and the like. In some embodiments, the system 102 may be implemented in the UE.

In one embodiment, the user equipment may be directly coupled to the system 102 via the network 114. In another embodiment, the user equipment may be coupled to the system 102 via an OEM (Original Equipment Manufacturer) cloud and the network 114. For example, the vehicles 106 may be a consumer vehicle or a probe vehicle and may be a beneficiary of the services provided by the system 102. In some example embodiments, the vehicles 106 may serve the dual purpose of a data gatherer and a beneficiary.

For example, the system 102 may be embodied as a cloud based service, a cloud based application, a cloud based platform, a remote server based service, a remote server based application, a remote server based platform, or a virtual computing system. In yet another example embodiment, the system 102 may be an OEM (Original Equipment Manufacturer) cloud. The OEM cloud may be configured to anonymize any data received by the system 102, such as from the vehicles 106, before using the data for further processing, such as before sending the data to map database 112b. In an example, anonymization of the data may be done by the mapping platform 110.

The network 114 may be wired, wireless, or any combination of wired and wireless communication networks, such as cellular, Wi-Fi, internet, local area networks, or the like. In some embodiments, the network 114 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The mapping platform 110 may comprise suitable logic, circuitry, and interfaces that may be configured to store one or more map attributes, sign data, and sensor data associated with traffic entities on link segments and links. The mapping platform 104 may be configured to store and update map data indicating the speed limit data along with other map attributes, road attributes and traffic entities, in the map database 112b. The mapping platform 110 may include techniques related to, but not limited to, geocoding, routing (multimodal, intermodal, and unimodal), clustering algorithms, machine learning in location based solutions, natural language processing algorithms, and artificial intelligence algorithms. Data for different modules of the mapping platform 110 may be collected using a plurality of technologies including, but not limited to drones, sensors, connected cars, cameras, probes, and chipsets. In some embodiments, the mapping platform 110 may be embodied as a chip or chip set. In other words, the mapping platform 10 may comprise one or more physical packages (such as, chips) that includes materials, components and/or wires on a structural assembly (such as, a baseboard).

In some example embodiments, the mapping platform 110 may include the processing server 112a for carrying out the processing functions associated with the mapping platform 110 and the map database 112b for storing map data. In an embodiment, the processing server 112a may comprise one or more processors configured to process requests received from the system 102. The processors may fetch sign data, sensor data and/or map data from the map database 112b and transmit the same to the system 102 in a format suitable for use by the system 102.

Continuing further, the map database 112b may comprise suitable logic, circuitry, and interfaces that may be configured to store sensor data and map data, which may be collected from the image sources and/or the vehicles 106 traveling on a link segment, or in a links. In accordance with an embodiment, such sensor data may be updated in real time or near real time such as within a few seconds, a few minutes, or on hourly basis, to provide accurate and up to date sensor data. The sensor data may be collected from any sensor that may inform the mapping platform 110 or the map database 112b of features within an environment that are appropriate for traffic related services. In accordance with an embodiment, the sensor data may be collected from any sensor that may inform the mapping platform 110 or the map database 112b of features within an environment that are appropriate for mapping. For example, motion sensors, inertia sensors, image capture sensors, proximity sensors, LIDAR (light detection and ranging) sensors, and ultrasonic sensors may be used to collect the sensor data. The gathering of large quantities of crowd-sourced data may facilitate the accurate modeling and mapping of an environment, whether it is a road link or a link within a structure, such as in an interior of a multi-level parking structure.

The map database 112b may further be configured to store the traffic-related data and road topology and geometry-related data for a road network as map data. The map data may also include cartographic data, routing data, and maneuvering data. The map data may also include, but not limited to, locations of intersections, diversions to be caused due to accidents, congestions or constructions, suggested roads or links to avoid, and ETAs depending on different links. In accordance with an embodiment, the map database 104b may be configured to receive the map data including the road topology and geometry-related attributes related to the road network from external systems, such as, one or more of background batch data services, streaming data services and third party service providers, via the network 110.

In some embodiments, the map database 112b may further store historical probe data for events (such as, but not limited to, traffic incidents, construction activities, scheduled events, and unscheduled events) associated with Point of Interest (POI) data records or other records of the map database 104b.

For example, the data stored in the map database 112b may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot or other types of navigation. While example embodiments described herein generally relate to vehicular travel, example embodiments may be implemented for bicycle travel along bike paths, boat travel along maritime navigational routes, etc. The compilation to produce the end user databases may be performed by a party or entity separate from the map developer. For example, a customer of the map developer, such as a navigation device developer or other end user device developer, may perform compilation on the received map database 112b in a delivery format to produce one or more compiled navigation databases.

In some embodiments, the map database 112b may be a master geographic database configured on the side of the system 102. In accordance with an embodiment, a client-side map database may represent a compiled navigation database that may be used in or with end user devices to provide navigation instructions based on the traffic data, the traffic conditions, speed adjustment, ETAs, and/or map-related functions to navigate through the intersection connected links on the route.

In some embodiments, the map data may be collected by end-user vehicles which use vehicles' on-board sensors to detect data about various entities such as road objects, lane markings, links, and the like. These vehicles are also referred to as probe vehicles and form an alternate form of data source for map data collection, along with ground truth data. Additionally, data collection mechanisms like remote sensing, such as aerial or satellite photography may be used to collect the map data for the map database 104a.

Returning to FIG. 2, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more processors configured in tandem via the bus to enable independent execution of instructions, pipelining and/or multithreading. Additionally or alternatively, the processor 202 may include one or more processors capable of processing large volumes of workloads and operations to provide support for big data analysis. In an example embodiment, the processor 202 may be in communication with the memory 204 via a bus for passing information among components of the system 102.

In an example, when the processor 202 is embodied as an executor of software instructions, the instructions may specifically configure the processor 202 to perform the algorithms and/or operations described herein when the instructions are executed. However, in some cases, the processor 202 may be a processor specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU) and logic gates configured to support operation of the processor 202. The network environment, such as, 100 may be accessed using the communication interface 206 of the system 102. The communication interface 206 may provide an interface for accessing various features and data stored in the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA or the like, the processor 202 may be specifically configured hardware for conducting the operations described herein.

In some example embodiments, the I/O interface 206 may communicate with the system 102 and displays input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may comprise user interface circuitry configured to control at least some functions of one or more I/O interface elements such as a display and, in some embodiments, a plurality of speakers, a ringer, one or more microphones and/or the like. The processor 202 and/or I/O interface 206 circuitry comprising the processor 202 may be configured to control one or more functions of one or more I/O interface 206 elements through computer program instructions (for example, software and/or firmware) stored on a memory 204 accessible to the processor 202. The processor 202 may further render notification associated with the navigation instructions, such as speed limit data, traffic conditions, ETA, routing information, road conditions, driving instructions, etc., on the user equipment or audio or display onboard the vehicles 108 via the I/O interface 206.

In some embodiments, the processor 202 may be configured to provide Internet-of-Things (IoT) related capabilities to users of the system 102 disclosed herein. The IoT related capabilities may in turn be used to provide smart city solutions by providing real time warnings, big data analysis, and sensor-based data collection by using the cloud based mapping system for providing accurate navigation instructions and ensuring driver safety. The I/O interface 206 may provide an interface for accessing various features and data stored in the system 102.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system, comprising:
a memory configured to store computer executable instructions; and
one or more processors configured to execute the instructions to:
receive sign data relating to one or more traffic entities, the sign data comprising at least one of: a set of speed values, a set of transportation mode values, and one or more entity parameters associated with the corresponding one or more traffic entities;
generate matching data based on a matching between the set of speed values and the set of transportation mode values, based on the one or more entity parameters; and
generate speed limit data based at least on: the matching data, the sign data and a predefined condition associated with transportation mode.

2. The system of claim 1, wherein the processor is further configured to:
generate a speed value cluster based on the one or more entity parameters, the speed value cluster comprising a set of speed cluster points corresponding to each of the set of speed values; and
generate a mode cluster based on the one or more entity parameters, the mode cluster comprising a set of mode cluster points corresponding to each of the set of transportation mode values.

3. The system of claim 2, wherein the processor is further configured to:
generate the matching data comprising one or more matching pairs based on the set of speed cluster points, the mode cluster points and a distance threshold, wherein
a matching pair from the one or more matching pairs comprises a first speed cluster point from the set of speed cluster points matched with a corresponding first mode cluster point from the set of mode cluster points, a distance between the first speed cluster point and the first mode cluster point being less than the distance threshold.

4. The system of claim 2, wherein the predefined condition comprises:
generate the speed limit data for a first transportation mode when two or more matching pairs from the matching data are associated with the first transportation mode and a distance between the two or more matching pairs is less than a predefined threshold;
generate the speed limit data when two or more speed cluster points from the set of speed cluster points are independent of mode cluster points and a distance between the two or more speed cluster points is less than the predefined threshold; and
generate the speed limit data for a first mode of transportation when one or more matching pairs from the matching data are associated with the first mode of transportation, one or more speed cluster points from the set of speed cluster points are independent of a mode of transportation and a distance between the one or more matching pairs and the one or more speed cluster points is less than the predefined threshold.

5. The system of claim 1, wherein the processor is further configured to
update a map database based on the generated speed limit data; and
generate navigation instructions based on the updated map database.

6. The system of claim 1, wherein the generated speed limit data indicates a decreasing speed limit data.

7. The system of claim 1, wherein the processor is further configured to:
generate the matching data and the speed limit data using a trained machine-learning based computational network, wherein the trained machine-learning based computational network is trained based on a set of vehicle features, a set of entity features and a set of map features.

8. The system of claim 7, wherein, to train the machine-learning based computational network, the processor is further configured to:
receive training data comprising a set of vehicle features of one or more vehicles, a set of entity features of one or more traffic entities, a set of map features and ground truth data associated with valid speed limit data and invalid speed limit data;
determine a plurality of features corresponding to the valid speed limit data and the invalid speed limit data, using the training data;
and
train the machine-learning based computational network to generate test speed limit data for one or more test sign data, using the plurality of features and the set of training data.

9. The system of claim 1, wherein the one or more entity parameter comprises:
at least one of: corresponding distance, corresponding heading, corresponding side of a road, and corresponding link ID relating to the corresponding one or more traffic entities.

10. The system of claim 6, wherein the processor is further configured to:
determine roadwork zone based on the speed limit data, the speed limit data indicating an end speed limit less than a speed threshold; and
generate navigation instructions based on the determine roadwork zone.

11. A method, comprising:
receiving sign data relating to one or more traffic entities, the sign data comprising at least one of: a set of speed values, a set of transportation mode values, and one or more entity parameters associated with the corresponding one or more traffic entities;
generating matching data based on a matching between the set of speed values and the set of transportation mode values, based on the one or more entity parameters; and
generating speed limit data based at least on: the matching data, the sign data and a predefined condition associated with transportation mode.

12. The method of claim 11, the method further comprising:
generating a speed value cluster based on the one or more entity parameters, the speed value cluster comprising a set of speed cluster points corresponding to each of the set of speed values; and
generating a mode cluster based on the one or more entity parameters, the mode cluster comprising a set of mode cluster points corresponding to each of the set of transportation mode values.

13. The method of claim 12, the method further comprising:
generating the matching data comprising one or more matching pairs based on the set of speed cluster points, the mode cluster points and a distance threshold, wherein
a matching pair from the one or more matching pairs comprises a first speed cluster point from the set of speed cluster points matched with a corresponding first mode cluster point from the set of mode cluster points, a distance between the first speed cluster point and the first mode cluster point being less than the distance threshold.

14. The method of claim 12, the method further comprising:
generating the speed limit data for a first transportation mode when two or more matching pairs from the matching data are associated with the first transportation mode and a distance between the two or more matching pairs is less than a predefined threshold;
generating the speed limit data when two or more speed cluster points from the set of speed cluster points are independent of mode cluster points and a distance between the two or more speed cluster points is less than the predefined threshold; and
generating the speed limit data for a first mode of transportation when one or more matching pairs from the matching data are associated with the first mode of transportation, one or more speed cluster points from the set of speed cluster points are independent of a mode of transportation and a distance between the one or more matching pairs and the one or more speed cluster points is less than the predefined threshold.

15. The method of claim 11, the method further comprising:
updating a map database based on the generated speed limit data; and
generating navigation instructions based on the updated map database.

16. The method of claim 11, wherein the generated speed limit data indicates a decreasing speed limit data.

17. The method of claim 11, the method further comprising:
generating the matching data and the speed limit data using a trained machine-learning based computational network, wherein the trained machine-learning based computational network is trained based on a set of vehicle features, a set of entity features and a set of map features.

18. The method of claim 17, wherein, to train the machine-learning based computational network, the method further comprising:
receiving training data comprising a set of vehicle features of one or more vehicles, a set of entity features of one or more traffic entities, a set of map features and ground truth data associated with valid speed limit data and invalid speed limit data;
determining a plurality of features corresponding to the valid speed limit data and the invalid speed limit data, using the training data; and
training the machine-learning based computational network to generate test speed limit data for one or more test sign data, using the plurality of features and the set of training data.

19. A computer program product comprising at least one non-transitory computer-readable storage medium having stored thereon computer-executable program code instructions which when executed by a computer, cause the computer to carry out operations, the operation comprising:
receiving sign data relating to one or more traffic entities, the sign data comprising at least one of: a set of speed values, a set of transportation mode values, and one or more entity parameters associated with the corresponding one or more traffic entities;
generating matching data based on a matching between the set of speed values and the set of transportation mode values, based on the one or more entity parameters;
generating speed limit data based at least on: the matching data, the sign data and a predefined condition associated with transportation mode;
generating a speed value cluster based on the one or more entity parameters, the speed value cluster comprising a set of speed cluster points corresponding to each of the set of speed values; and
generating a mode cluster based on the one or more entity parameters, the mode cluster comprising a set of mode cluster points corresponding to each of the set of transportation mode values.

20. The computer program product of claim 19, the operations further comprising:
generating the matching data comprising one or more matching pairs based on the set of speed cluster points, the mode cluster points and a distance threshold, wherein
a matching pair from the one or more matching pairs comprises a first speed cluster point from the set of speed cluster points matched with a corresponding first mode cluster point from the set of mode cluster points. a distance between the first speed cluster point and the first mode cluster point being less than the distance threshold.
